(19) United States
(12) Patent Application Publication
(10) Pub. No.: US 2005/0161144 A1
(43) Pub. Date: Jul. 28, 2005

(54) Bond apparatus, bonding method and the composition bonded thereby

(75) Inventors: Shoji Nakajima, Osaka (JP); Kumiko Mihara, Osaka (JP)

Correspondence Address: SHERIDAN ROSS PC, 1560 BROADWAY, SUITE 1200, DENVER, CO, 80202, US

(73) Assignee: Kabushikikaisha Gingam, Osaka (JP)

(21) Appl. No.: 11/084,617

(22) Filed: Mar. 17, 2005

Related U.S. Application Data
(62) Division of application No. 10/084,266, filed on Feb. 25, 2002.

(30) Foreign Application Priority Data
Feb. 26, 2001 (JP) 2001-50629

(51) Int. Cl. B32B 31/00

(52) U.S. Cl. 156/73.1; 156/498; 156/580.1

(57) ABSTRACT

To provide a method for bonding a second member with a fixed shape (e.g. crystal glass) to a first member with a flexible and flat configuration (e.g. cloth, leather, and the like) with a hot-melt adhesive in a short process so as to have a high peel resistance and a beautiful appearance, a bonding apparatus and a composition bonded thereby. The bonding method of the present invention comprises the steps of placing a second member with a fixed shape on a first member with a flexible and flat configuration with a hot-melt adhesive being sandwiched therebetween, heating at least the second member up to a temperature equal to or greater than a melting point of the hot-melt adhesive, and cooling the first member and the second member while pressing the second member so as to contact the first member closely.

### BACKGROUND OF THE INVENTION

The present invention relates to a method for bonding a second member with a fixed shape to a first member with a flexible and flat configuration with a hot-melt adhesive, a bonding apparatus and a composition bonded by the method.

Cloth, leather and the like are widely used as furnishing such as clothes, bag, hat, gloves, shoes, and the like; furniture (curtain, tablecloth, outer material for sofa, table and chair, stationary pad, book cover, and the like); interior equipments of vehicle (outer material of seat, inner surface of door, and the like) and the like.

These goods follow a fashion. Goods with new design or excellent design have high commercial value.

For example, clothes manufacturers have decorated clothes with small-sized crystal glasses, precious stones and the like, thereby enhancing commercial value of goods and providing consumers with new design.

When a small-sized crystal glass with a fixed shape or the like is attached to cloth with a flexible and flat configuration or the like, it is required to make the attachment structure invisible from outside and prevent fabric around the attachment part from suffering any damage, as well as to make the adhesive strength strong enough.

Generally, the cloth and the like with crystal glasses or precious stones are often used for expensive goods. For that reason, quality standards as to the invisibleness of the attachment structure, the absence of undesired trace on cloth, and so on are very high.

One of the methods for attaching a second member with a fixed shape (e.g. small crystal glass) to a first member with a flexible and flat configuration (e.g. cloth) so as to make the attachment structure invisible from outside is to bond the second member to the first member with a hot-melt adhesive.

Although the size of the crystal glass, precious stone, or the like to be bonded to a cloth or the like is optional, it is usually smaller than 10 mm cube, more typically 5 mm cube (e.g. crystal glass with a diameter of about 1 to 3 mm).

FIG. 3 shows a conventional bonding method for bonding a second member to a cloth as a first member with the hot-melt adhesive (prior art 1).

The bonding method in the prior art 1 will be described hereinafter.

The prior art 1 embodies a method for bonding a small-sized crystal glasses 11 (the same one as in the second member) to a cloth 13 (the same one as in the first member) with the hot-melt adhesive 12.

FIG. 3(a) shows a first step of the bonding method in the prior art 1.

In FIG. 3(a), the crystal glass 11 is affixed at a predetermined position (in accordance with design) on the adhesive side of an adhesive sheet 110 to which an adhesive is applied. A top surface of the crystal glass 11 is fixed to the adhesive sheet 110. The adhesive sheet 110 is used for locating the crystal glass 11 in place during manufacturing phase (bonding phase).

The cloth 13 is spread evenly on a table 14 and the crystal glass 11 (affixed to the adhesive sheet 110) with the hot-melt adhesive 12 pasted on its bottom is placed on a predetermined position (in accordance with design) (placing step). At the placing step carried out at normal temperature, the hot-melt adhesive 12 is in a solid state.

Next, the operation goes to a step shown in FIG. 3(b). At the step of FIG. 3(b), in a chamber 33 having internal heating temperature of 180° C., the cloth 13 spread evenly on a bed 32 and the crystal glass 11 (affixed to the adhesive sheet 110) are pressed to each other by a press device (including a slide 31 and the bed 32) for 15 to 45 seconds (heating step). At the heating step of FIG. 3(b), the press applied to the cloth 13 and the crystal glass 11 by the slide 31 is 2 kgf/cm² (34 is pressing direction).

The melting point of the hot-melt adhesive used in this prior art is 130° C.

At the heating step of FIG. 3(b), the hot-melt adhesive 12 heated up to 180° C. melts at the position between the crystal glass 11 and the cloth 13.

Next, the operation goes to a step shown in FIG. 3(c). At the step of FIG. 3(c), the crystal glass 11 (affixed to the adhesive sheet 110) and the cloth 13 which sandwich the hot-melt adhesive 12 therebetween are spread on a table 35 so as to be cooled down by themselves at normal temperatures (cooling step).

As a result, the hot-melt adhesive 12 becomes hardened, thereby fixing the crystal glass 11 to the cloth 13.

After hardening of the hot-melt adhesive 12, the adhesive sheet 110 is removed.

FIG. 4 shows a conventional bonding method for bonding a second member (e.g. crystal glass) to cloth as a first member with a hot-melt adhesive (prior art 2).

Leather used as material for clothes, handbag, shoes, and the like is provided with a waterproof layer on its surface in order to obtain waterproof property. The waterproof layer is thin and weak in tensile strength.

Even if the small-sized crystal glass as the second member is fixed to the waterproof layer of the leather with the hot-melt adhesive, the waterproof layer bonded to the second member is easily peeled off therefrom with a small impact to the second member. For that reason, it has been conventionally believed impossible to bond the second member to leather directly.

Up to now, a bonding method in the prior art 2 has been used to bond the second member such as crystal glass for ornament or the like to leather.

Hereinafter, the bonding method of prior art 2 will be described.

The prior art 2 embodies a method for bonding a small-sized crystal glass 11 (the same one as in the second member) to a leather 201 (the same one as in the first member) with the hot-melt adhesive 12.

The leather 201 has a waterproof layer 202 which is formed on a surface of a leather 203 as a base.

FIG. 4(a) shows a first step of the boding method in the prior art 2. A slide 41 and a bed 42 are male and female trimming dies, respectively. Both parts constitute a press device (The slide 41 applies press in the direction of an arrow 43). In FIG. 4(a), the slide 41 and the bed 42 make a hole in the leather 201 at the position where the crystal glass 11 is attached. As a result, as shown in FIG. 4(b), a hole 44 is formed in the leather 201 at the attachment position of the crystal glass 11.

Next, the operation goes to a step shown in FIG. 4(c).

The crystal glass 11 is affixed at a predetermined position (in accordance with design) on the adhesive side of adhesive sheet 110 to which an adhesive is applied. A top surface of the crystal glass 11 is fixed to the adhesive sheet 110. The adhesive sheet 110 is used for locating the crystal glass 11 in place during manufacturing phase (bonding phase).

In FIG. 4(c), a cloth 46 is placed on a table 14. The cloth 46 has a cloth 48 as a base on which a hot-melt adhesive 47 is applied.

The leather 201 (FIG. 4(b)) with the hole is placed on the cloth. The crystal glass 11 (affixed to the adhesive sheet 110) is inserted in the hole 44 formed in the leather 201. The hot-melt adhesive 12 is applied to the bottom surface of the crystal glass 11.

As the step of FIG. 4(c) is carried out at normal temperatures, the hot-melt adhesives 47 and 12 keep hardened.

Next, the operation goes to a step shown in FIG. 4(d). At the step of FIG. 4(d), in a chamber 33 having internal heating temperature of 180° C., the cloth 46 and the leather 201 spread evenly on a bed 32, and the crystal glass 11 (affixed to the adhesive sheet 110) are pressed to each other by a press device (including a slide 31 and the bed 32) for 15 to 45 seconds (heating step). At the heating step, the press applied to the cloth 46, the leather 201 and the crystal glass 11 by the slide 31 is 2 kgf/cm² (34 is the pressing direction).

The melting point of the hot-melt adhesive 12 and 47 used in this prior art is 130° C.

At the heating step, the hot-melt adhesive 12 heated up to 180° C. melts between the crystal glass 11 and the cloth 48. Similarly, the hot-melt adhesive 47 heated up to 180° C. melts between the cloth 48 and the leather 201.

Next, the operation goes to a step shown in FIG. 4(e). At the step of FIG. 4(e), the crystal glass 11, the cloth 48 and the leather 201 which sandwich the melted hot-melt adhesives 12 and 47, respectively, therebetween are spread on a table 35 so as to be cooled down by themselves at normal temperatures (cooling step).

As a result, the hot-melt adhesive 12 becomes hardened, thereby fixing the crystal glass 11 to the cloth 48. Similarly, the hot-melt adhesive 47 becomes hardened, thereby fixing the cloth 48 11 to the leather 201 (a waterproof layer is not formed on the back surface of the leather 201).

According to the above-mentioned bonding method, the crystal glass 11 is fixed to the leather 201 via the cloth 48.

After hardening the hot-melt adhesives 12 and 47, the adhesive sheet 110 is removed.

The method in the prior arts 1 and 2 has a problem that cannot achieve sufficient high peel resistance.

According to the method in prior arts 1 and 2, the cloth is pressed in high temperature atmosphere (180° C.) for a long time (15 to 45 seconds) so that the melted hot-melt adhesive penetrates deep into fibers of the cloth thereby obtaining a high peel resistance (FIG. 3(b) and FIG. 4(d)). However, when time for the application of press exceeds 10 seconds, a trace of a press die (slide 31) appears.

The method in the prior arts 1 and 2 has a problem of giving damage on appearance of the bonded cloth or leather.

The method in the prior arts 1 and 2 has a problem of shrinking the cloth or leather in high temperature atmosphere.

The method in the prior arts 1 and 2 has a problem of requiring long time for bonding due to a long pressing time (15 to 45 seconds).

The method in the prior art 2 has a problem that only the portion of the leather 201 to which the cloth 48 is affixed loses flexibility.

An object of the present invention is to provide a method for bonding a second member with a fixed shape (e.g. crystal glass) to a first member with a flexible and flat configuration (e.g. cloth, leather) with a hot-melt adhesive in a short process so as to have a high peel resistance and a beautiful appearance, a bonding apparatus and a composition bonded thereby.

### BRIEF SUMMARY OF THE INVENTION

In order to solve the above-mentioned problems, the present invention has the following aspects.

A bonding method according to an aspect of the present invention comprises the steps of
placing a second member with a fixed shape on a first member with a flexible and flat configuration with a hot-melt adhesive being sandwiched therebetween,
heating at least the above-mentioned second member up to the temperature equal to or greater than the melting point of the above-mentioned hot-melt adhesive, and
cooling the above-mentioned first member and the above-mentioned second member while pressing the above-mentioned second member so as to contact the above-mentioned first member closely.

A bonding apparatus according to another aspect of the present invention comprises:
a heating section for heating at least a second member up to a temperature equal to or greater than a melting point of a hot-melt adhesive, while the above-mentioned second member with a fixed shape is placed on a first member with a flexible and flat configuration with the above-mentioned hot-melt adhesive being sandwiched therebetween and
a cooling section for cooling the above-mentioned first member and the above-mentioned second member while pressing the above-mentioned second member so as to contact the above-mentioned first member closely.

A composition according to still another aspect of the present invention comprises a first member with a flexible and flat configuration, and a second member with a fixed shape which is bonded with a hot-melt adhesive on said second member wherein
a portion of the above-mentioned first member contacting the above-mentioned second member becomes hardened in a compressed state.

The conventional bonding methods required an extended time period for heating step for making the hot-melt adhesive penetrates deep into fibers of the first member in order to obtain more than certain level of adhesive strength. Such extended time heating, however, has deteriorated the quality of the first member (The first member bears a trace of press. Further, as the hot-melt adhesive spread widely, a portion of the first member which surrounds the second member (e.g. crystal glass for ornament) would change in quality. Furthermore, It took a long time to bond.

According to the present invention, as the hot-melt adhesive becomes hardened in a pressed state at the cooling step (or cooling device), a sufficient adhesive strength is achieved, and time period for the heating step can be shortened.

The present invention has an advantage of achieving a method for bonding the second member with a fixed shape (e.g. crystal glass) to the first member with a flexible and flat configuration (e.g. cloth, leather, and the like) with a hot-melt adhesive in a short process so as to have a high peel resistance and a beautiful appearance (without shrinkage of cloth or trace of press), a bonding apparatus and a bonded composition.

In the conventional bonding method, a tip of the hot-melt adhesive which penetrates into fibers of the cloth became minute needle-shaped. Accordingly, when users put on clothes made of this cloth, the tip of the hot-melt adhesive is stuck into their body through the back surface of the cloth, causing discomfort.

In the method according to the aspect of the present invention, as the hot-melt adhesive becomes hardened in a pressed state, the surface of the hardened hot-melt adhesive is flat and smooth (The reason is that the surface of the bed of the press device is flat-shaped). When users put on clothes made of this cloth, they feel no discomfort even when the surface of the hot-melt adhesive touch their skin as the surface of the hot-melt adhesive is smooth.

“First member with a flexible and flat configuration” includes a flexible member that becomes flat at least in the vicinity of the position on which a second member is mounted when placed on a flat surface (e.g. cloth, leather, clothes (As a whole, it is flexible and three-dimensional shape. By placing it on a flat surface, the portion to which the second member is attached and its vicinity can be made flat-shaped.) and the like), and a flexible member which is attached to the surface of a member with a fixed shape (shape of this member is optional and may not be flat.) and is flat at least in the vicinity of the attachment position of the second member (e.g. a wooden box, flat surface of which is covered with leather).

“Flat shape” means a shape having a two dimensional (flat) area greater than thickness.

“Second member with a fixed shape” means a member having a fixed-shape which is not easy to be transmuted such as crystal glass.

“Hot-melt adhesive” is a generic term referring to adhesive that goes into a liquid state having fluidity due by heating and returns into a solid state by cooling.

“Sandwich a hot-melt adhesive therebetween” means that the hot-melt adhesive is placed between the first member and the second member.

At the placing step, the method for “sandwiching the hot-melt adhesive” is optional.

For example, at first the hot-melt adhesive is thinly pasted on the second member with a fixed shape. Then, the second member is placed on the first member so that the pasted adhesive is located between the first member and the second member (This is referred to as the first method).

For example, at first the hot-melt adhesive (e.g. minute film adhesive) is placed at the predetermined position on the first member (the position on which the second member is placed) or is thinly pasted on the first member. Next, the second member is placed at the predetermined position on the first member (the position where the hot-melt adhesive is placed or pasted) (This is referred to as the second method).

In the case that the first member is an extendable member (e.g. cloth, leather and the like), the first method is preferable since in the second method, it is difficult to match exactly the hot-melt adhesive applying position to the second member placement position.

In a bonding method according to a further aspect of the invention, the heating temperature is preferably 200° C. or less and heating time is 10 seconds or less at the above-mentioned heating step.

In a bonding apparatus according to a still further aspect of the invention, the heating temperature is preferably 200° C. or less and heating time is 10 seconds or less at the above-mentioned heating section.

The above-mentioned species has an effect of achieving a bonding method and a bonding apparatus for melting the hot-melt adhesive without causing damage to the first member (e.g. cloth or leather).

Preferably, heating temperature is higher than melting temperature of the hot-melt adhesive by 20 to 50° C. and heating time is 5 seconds or less. In the method according to a still further aspect of the invention, heating time is set at 1 second or less. This ensures melting of the hot-melt adhesive and prevents the first member from changing in quality due to heat.

In a bonding method according to a still further aspect of the invention, the above-mentioned first member and the above-mentioned second member may be pressed to each other so as to contact each other closely, and the above-mentioned second member is heated through a press device contacting the above-mentioned second member at the above-mentioned heating step.

In a bonding method according to a still further aspect of the invention, the above-mentioned first member and second member may be pressed to each other so as to contact each other closely, and the above-mentioned second member is heated by suffering ultrasonic vibration through the press device contacting the above-mentioned second member at the above-mentioned heating step.

In a bonding method according to a still further aspect of the invention, part of a portion of the above-mentioned first member contacting the above-mentioned second member is transmuted or removed at least partially due to heat at the above-mentioned heating step.

In a bonding apparatus according to a still further aspect of the invention, the above-mentioned heating section presses the above-mentioned first member and the above-mentioned second member to each other so as to contact each other closely and heats the above-mentioned second member through a press device in contact therewith.

In a bonding apparatus according to a still further aspect of the invention, the above-mentioned heating section is a ultrasonic press device which presses the above-mentioned first member and the above-mentioned second member to each other so as to contact each other closely and heats the above-mentioned second member by applying ultrasonic vibration to the above-mentioned second member through a press device in contact therewith.

In the above-mentioned species, the second member is heated through the press device while the first member and the second member are pressed to each other. As the second member is firmer and generally taller than the first member, the slide of the press device contacts only the second member and heats the second member intensively.

In a bonding apparatus according to a still further aspect of the invention, the press device contacts the second member and the ultrasonic vibration press device supplies only the second member with energy (heats).

Therefore, the second member, and the portion of the hot-melt adhesive and the first member directly contacting the second member are heated rapidly, and other portion of the first member is hardly heated.

The bonding method and the bonding apparatus of the above-mentioned species are further superior because the first member suffers no degradation due to heat at the time of melting the hot-melt adhesive.

Leather used as material for clothes, handbag, shoes, and the like is provided with a waterproof layer on its surface in order to obtain waterproofing property. The waterproof layer is thin and weak in tensile strength.

In the conventional bonding method and bonding apparatus, it was very difficult to bond the second member with a fixed shape such as crystal glass to the member having a waterproof layer of low tensile strength (e.g. leather).

In the bonding method and the bonding apparatus of the above-mentioned species, by heating the second member strongly (by applying strong ultrasonic vibration to the second member for a short time), the temperature of the portion directly contacting the second member increases rapidly. The hot-melt adhesive contacting the second member melts and at the same time, the waterproof layer of the first member directly contacting the second member is transmuted or removed.

After removal of the waterproof layer, the hot-melt adhesive becomes hardened at the cooling step (or the cooling device), resulting in that the second member is bonded directly to the first member having a strong tensile strength (e.g. leather as base).

As only the portion of the waterproof layer directly contacting the second member (the portion immediately underneath the second member) is transmuted or removed, the transmuted or removed portion is invisible from outside. Thus the first member to which the second member is attached has a beautiful appearance.

When the transmuted or removed portion of the first member spread over the periphery of the second member, the first member decreases in strength.

Especially in the case that the first member and the second member are materials for articles of taste such as clothes, bag, shoes and the like, when the transmuted or removed portion of the first member spread over the periphery of the second member, the first member and the second member become unusable as material for commercial products.

Therefore, it is very important to restrict the transmuted or removed portion of the first member to the portion just under the second member which is invisible from outside after bonding.

As to a phenomenon that the layer of low tensile strength is transmuted or removed by the application of heat with ultrasonic vibration, the specific content of the phenomenon is optional. For example, part of the waterproof layer melts and evaporates. Alternatively, the waterproof layer melts and the melted part is pulled by surface tension toward the unmelted part on periphery thereof so that the portion of waterproof layer directly contacting the second member disappears. Alternatively, part of the waterproof layer burns to become carbonized or disappear.

“Ultrasonic press device” is, for example, a device wherein a welding tip of an ultrasonic welder is replaced by the slide.

Applicable object of the present invention is optional in the extent that the second member with a fixed shape is bonded to the first member with a flexible and flat configuration with the hot-melt adhesive. For example, the first member is a member with a flexible and flat configuration on which an optional layer is formed.

In a bonding method according to a still further aspect of the invention, the above-mentioned heating step is carried out so as to make a portion of the above-mentioned first member contacting the above-mentioned second member after bonding be thinner than the above-mentioned first member before bonding and not to have a through-hole.

A composition according to a still further aspect of the invention comprises a first member with a flexible and flat configuration, and a second member with a fixed shape which is bonded with a hot-melt adhesive on said second member wherein
a portion of the above-mentioned first member contacting the above-mentioned second member is thinner than other portion of above-mentioned first member in thickness and does not have a through-hole.

In a composition according to a still further aspect of the invention, a part of a portion of the above-mentioned first member contacting the above-mentioned second member is transmuted or removed at least partially in the direction of thickness of the above-mentioned first member due to heat.

In the bonding method in the prior art 2, a through-hole is made in the leather and the crystal glass inserted into the through-hole is fixed to a cloth attached to the back surface of the leather. However, the portion of the leather that the cloth is attached on its back surface is inferior to other portion of the leather in flexibility. This reduces the value of such articles using leather with backing cloth (e.g. clothes).

Moreover, the method in prior art 2 has a lot of processes.

In the bonding method and the composition according to the aspect of the invention, the waterproof layer and the like on the leather are removed by heating, and after removal of the waterproof layer and the like, the second member such as crystal glass is bonded directly to the leather. As the leather requires no backing cloth, the portion of the leather to which the crystal glass is bonded has same flexibility as other portion of the leather. The composition manufactured by the bonding method of the present invention and the composition of the present invention have a high commercial value.

The bonding method (or the composition) according to the aspect of the invention can carry out bonding with a small number of processes.

When the entire first member becomes transmuted in the direction of thickness due to heat, peel resistance of the member decreases. In the aspect of the present invention, a part of the first member becomes transmuted in the direction of thickness due to heat, the waterproof layer is removed and the portion necessary for supporting the second member remains so that the first member has a strong peel resistance.

In a bonding method according to a still further aspect of the invention, heating is performed at an output power of preferably 800 to 2000 W for 3 seconds or less at the above-mentioned heating step.

In a bonding apparatus according to a still further aspect of the invention, the above-mentioned heating section heats at an output power of preferably 800 to 2000 W for 3 seconds or less.

The bonding method and the bonding apparatus of the above-mentioned species remove the surface layer of the first member and melt the hot-melt adhesive at an appropriate temperature and for an appropriate time period. After removal of the surface layer, the second member such as crystal glass is bonded directly to the first member.

In a bonding method according to a still further aspect of the invention, the above-mentioned cooling step is carried out within 2 seconds after completing the above-mentioned heating step.

A bonding apparatus according to a still further aspect of the invention further comprises a transferring section for transferring the above-mentioned first member and the above-mentioned second member from the above-mentioned heating section to the above-mentioned cooling section within 2 seconds.

At the heating step (or the heating section) of the bonding of the above-mentioned species, only the second member and periphery thereof are heated and other portion is not heated. Therefore, after completion of the heating step, the hot-melt adhesive is rapidly cooled down by itself. If the hot-melt adhesive should start hardening before being cooled under press, this weakens the present invention's effect of bonding with a strong adhesive strength. The above-mentioned species achieves the effect of bonding with a strong adhesive strength.

Preferably, the cooling step is carried out within 1 second after completion of the heating step. More preferably, the heating step proceeds to the cooling step within about 0.5 second or less.

In a bonding method according to a still further aspect of the invention, the above-mentioned first member is made of cloth, leather, resin or paper, and the above-mentioned second member is made of glass, stone, pottery, porcelain, metal or resin.

In a composition according to a still further aspect of the invention, the above-mentioned first member is made of cloth, leather, resin or paper, and the above-mentioned second member is made of glass, stone, pottery, porcelain, metal or resin.

The present invention has an advantage of achieving the bonding method for bonding various types of first members to various types of second members and the bonded composition. As a example, the boding method for bonding the second member (e.g. crystal glass) for ornament to clothes, furniture and interior equipments of vehicles and the like (comprising the first member) can be achieved.

“Cloth” includes natural fabric and artificial fabric. “Cloth” includes articles knitted with woolen yarn (knitted articles and the like). “Leather” includes natural leather and artificial leather. The present invention is suitable, for example, for bonding the second member for ornament to cloth, leather or the like for clothes, bag, hat, gloves, shoes or the like; cloth, leather or the like for furniture such as sofa, bed, table or the like; cloth, leather or the like for seats of vehicle such as car, airplane, train or the like.

“Stone” includes crystal, precious stone and the like.

In a bonding method according to a still further aspect of the invention, a third member with a flat shape and appropriate hardness and flexibility is sandwiched between at least one of surfaces of the above-mentioned first member as well as the above-mentioned second member contacting the above-mentioned press device and the above-mentioned press device, and pressed at least at either of the above-mentioned heating step or the above-mentioned cooling step.

In a bonding apparatus according to a still further aspect of the invention, a third member with a flat shape and appropriate hardness and flexibility is sandwiched between the above-mentioned first member as well as the above-mentioned second member and at least one of surfaces of the above-mentioned heating section or the above-mentioned cooling section contacting the above-mentioned first member or the above-mentioned second member, and pressed.

In a bonding method according to a still further aspect of the invention, the above-mentioned third member is Teflon (trademark) glass sheet.

By pressing the third member (preferably Teflon (trademark) glass sheet) mounted on the first member and the second member, the third member carries out the following three functions (The first member and the second member are optional).

The Teflon (trademark) glass sheet is a glass-cloth coated by Teflon (trademark. It means polytetrafluoroethylene. Fluorine-contained polymers) at high temperatures.

First, the Teflon (trademark) glass sheet prevents the first member and the second member from being damaged due to contact with the metallic slide of the press device.

Secondly, even in the case that a plurality of second members attached to the first member vary in height, the flat-shaped Teflon (trademark) glass sheet which has suitable hardness (not too soft) and bends suitably can apply sufficient press to a short second member as well as a tall one. Various sizes of the second members may be attached to the first member, in accordance with design. Provided that height differences among plural types of the second members fall within a certain range, the use of the third member makes it possible to bond plural types of the second members having different heights to the first leather in one bonding process.

Thirdly, the third member also serves as fixing the second member at the placed position while the first member and the second member are transferred or pressed.

By pressing the third member (preferably Teflon (trademark) glass sheet) placed under the first member, the third member carries out the following two functions (The first member and the second member are optional).

First, the third member prevents the first member from being damaged due to contact with the metallic bed of the press device.

Secondly, by transferring the first member and the second member which are mounted on the third member, transfer of the flexible first member is facilitated.

The novel features of the invention are set forth with particularity in the appended claims. The invention as to both structure and content, and other objects and features thereof will best be understood from the detailed description when considered in connection with the accompanying drawings.

### BRIEF DESCRIPTION OF THE DRAWINGS

FIG. 1 shows a bonding apparatus and a bonding method in an embodiment 1 of the present invention;

FIG. 2 shows a bonding apparatus and a bonding method in an embodiment 2 of the present invention;

FIG. 3 shows a bonding method in a prior art 1;

FIG. 4 shows a bonding method in a prior art 2.

Part or all of the drawings are drawn schematically for diagrammatic representation and it should be considered that they do not necessarily reflect real relative size and position of components shown therein.

### DETAILED DESCRIPTION OF THE INVENTION

Embodiments embodying best modes to practice the present invention will be now described by reference to the appended drawings.

### Embodiment 1

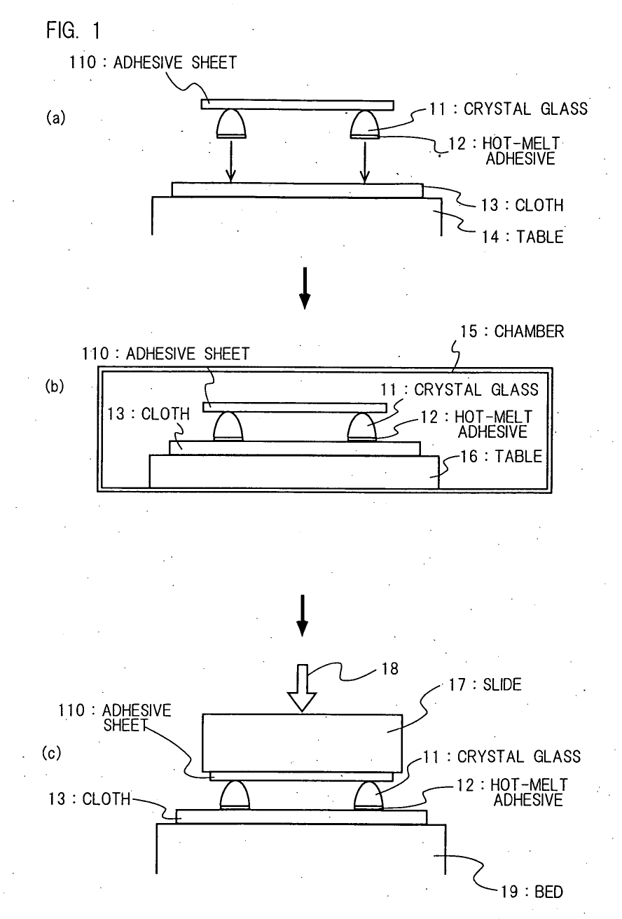

FIG. 1 shows a bonding apparatus and a bonding method of an embodiment 1 according to the present invention wherein a second member is bonded to a cloth as a first member with a hot-melt adhesive.

The embodiment 1 is described hereinafter.

The embodiment 1 shows a method for bonding a small-sized crystal glass 11 (the same one as in the second member) to a cloth 13 (the same one as in the first member) with a hot-melt adhesive 12.

The type of the hot-melt adhesive is optional. The hot-melt adhesive used in the embodiment 1 is an adhesive of high-density polyethylene and its melting point is 130° C.

The bonding apparatus of the embodiment 1 comprises tables 14, 16, a chamber 15 and a press device (including a slide 17 and a bed 19).

FIG. 1(a) shows a first step of the bonding method in the embodiment 1.

In FIG. 1(a), the crystal glass 11 is affixed at a predetermined position (in accordance with design) on the adhesive side of an adhesive sheet 110 to which the adhesive is applied. A top surface of the crystal glass 11 is fixed to the adhesive sheet 110. The adhesive sheet 110 is used for locating the crystal glass 11 in place during manufacturing phase (bonding phase).

In FIG. 1(a), the cloth 13 is spread evenly on the table 14 and the crystal glass 11 (affixed to the adhesive sheet 110) with the hot-melt adhesive 12 pasted on its bottom is placed on a predetermined position (in accordance with design) (placing step). At the placing step carried out at normal temperature, the hot-melt adhesive 12 is in a solid state.

Next, the operation goes to a step shown in FIG. 1(b). At the step of FIG. 1(b), the cloth 13 spread evenly on a table 16 and the crystal glass 11 (affixed to the adhesive sheet 110) are placed in the chamber 15 having internal heating temperature of 150 to 180° C. for 2 to 5 seconds (heating step).

At the heating step of FIG. 1(b), the hot-melt adhesive 12 heated to 150 to 180° C. melts between the crystal glass 11 and the cloth 13.

Next, the operation goes to a step shown in FIG. 1(c). In FIG. 1(c), the crystal glass 11 (affixed to the adhesive sheet 110) and the cloth 13 which sandwich the melted hot-melt adhesives 12 therebetween are cooled down at normal temperatures while being pressed to each other by the press device (including the slide 17 and the bed 19) (cooling step). The press applied to the cloth 13 and the crystal glass 11 by the slide 17 is 5 kgf/cm² (18 is pressing direction).

Thus the hot-melt adhesive 12 becomes hardened, thereby fixing the crystal glass 11 to the cloth 13.

After the hardening of the hot-melt adhesive, the adhesive sheet 110 is removed.

It is desirable to effect a rapid transition from the heating step of FIG. 1(b) to the cooling step of FIG. 1(c) (before starting the hardening of the hot-melt adhesive).

In the conventional bonding method, the crystal glass 11 and the cloth 13 were pressed to each other at the step of melting the hot-melt adhesive and not pressed during cooling.

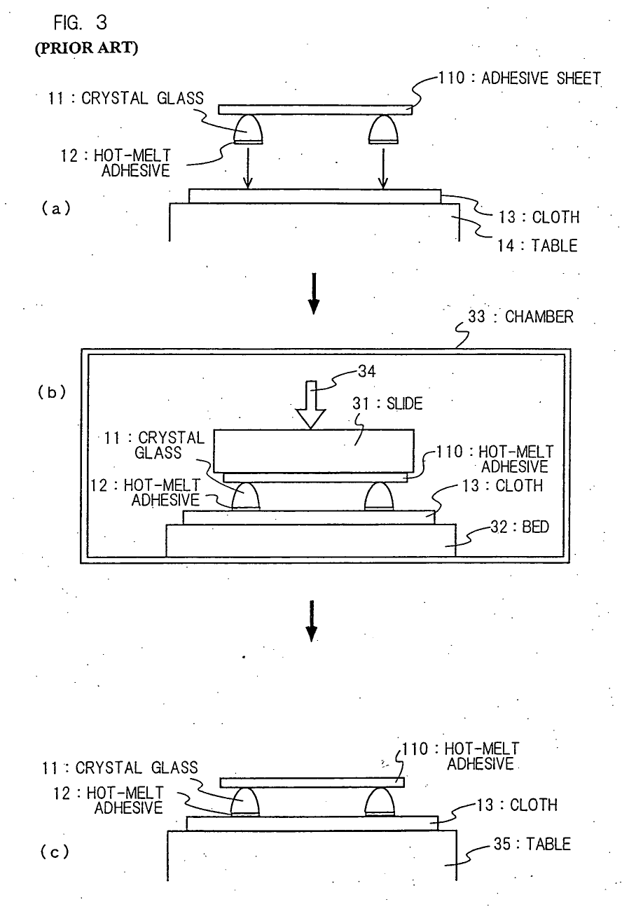

By heating under press, the hot-melt adhesive was penetrated deep into fibers of the cloth (FIG. 3(b)) and was left untouched until it hardened (FIG. 3(c)).

In the conventional bonding method, the hot-melt adhesive 12 spreaded widely and hardened twinning in loosely-woven sparse fibers of the cloth 13 at the portion of the cloth 13 contacting the crystal glass 11.

Inventor of the present invention found that by cooling the crystal glass 11 and the cloth 13 under press, they can be bonded with each other so as to have a higher peel resistance than prior art.

By the application of press at the cooling step, the thickness of the cloth 13 directly underneath the crystal glass 11 become thinner. In the state where fibers of the portion of cloth 13 contacting the crystal glass 11 are compressed, the hot-melt adhesive 12 twines in the fibers and becomes hardened.

As the hot-melt adhesive 12 twines in the high-density fibers of the cloth 13 in a compressed state and solidifies, it has a higher adhesive strength than that of the prior arts.

For example, according to the bonding method in the embodiment 1, a crystal glass can be bonded to articles knitted with woolen yarn (so-called knitted article). In the case of the conventional bonding method, it was very difficult to bond a crystal glass to knitted article consisting of very low-density fibers. According to the bonding method of the embodiment 1, as the hot-melt adhesive twines in the high-density fibers of the woolen yarn in a compressed state and becomes hardened, the crystal glass is bonded to the woolen yarn with a sufficient adhesive strength.

In this embodiment, as the hot-melt adhesive 12 needs not to penetrate into a large area of the cloth 13, time period for the heating step can be shortened. The time period when the cloth 13 is placed in a high temperature atmosphere (2 to 5 seconds) is much shorter than 10 seconds (i.e. threshold value beyond which the cloth 13 bears a trace when the cloth 13 is placed in a high temperature atmosphere), thereby preventing the cloth 13 from being damaged.

The hot-melt adhesive 12 does not spread outside of the portion of the cloth 13 directly contacting the crystal glass 11. Therefore, the crystal glass 11 and the cloth 13 after bonding have no trace visible from outside, giving a beautiful appearance.

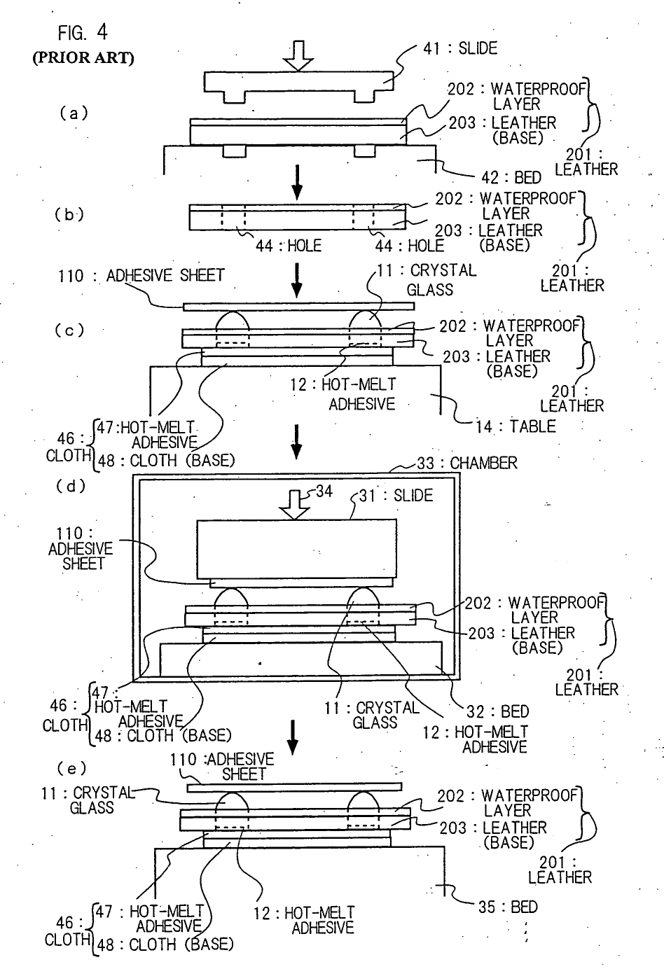

In the heating step (FIG. 3(b), FIG. 4(d) of the prior arts and FIG. 1(b) of the embodiment 1), the cloth 13 has shrunk a little and has been transmuted. In the conventional bonding method, the shrinkage and deformation of the cloth 13 occurring at the heating step were not restored.

In the present invention, however, the cloth 13 which has shrunk due to heat is extended restoring the former shape and fixed at the position. In this state, the next cooling step is carried out (it is cooled under press). This allows the cloth 13 to return to the original shape and size.

The time period (2 to 5 seconds) for the heating step of the bonding apparatus and the bonding method according to the present invention is shorter than that of the bonding method in the prior art (15 to 45 seconds).

The time period for the cooling step of the bonding apparatus and the bonding method according to the present invention (Cooling is performed under press by the slide 17 having a large heat capacity and a high heat conductivity at normal temperatures) is shorter than that for the cooling step in the prior art (Cooling is performed automatically by itself in the atmosphere).

Therefore, the time period for bonding in the bonding apparatus and the bonding method according to the present invention is much shorter than that of the prior art.

In the extent that the second member with a fixed shape is bonded to the first member with a flexible and flat configuration with the hot-melt adhesive, the material of the first member and the second member is optional. For example, the first member is made of cloth, resin or paper, and the second member is made of glass, stone (crystal, precious stone, and the like), pottery, porcelain, metal or resin.

The size of the second member is optional, for example, a size smaller than 10 mm cube, more typically smaller than 5 mm cube.

### Embodiment 2

An embodiment 2 features a method for bonding a small-sized crystal glass 11 (the same one as in the second member) to a leather 201 (the same one as in the first member) with a hot-melt adhesive 12.

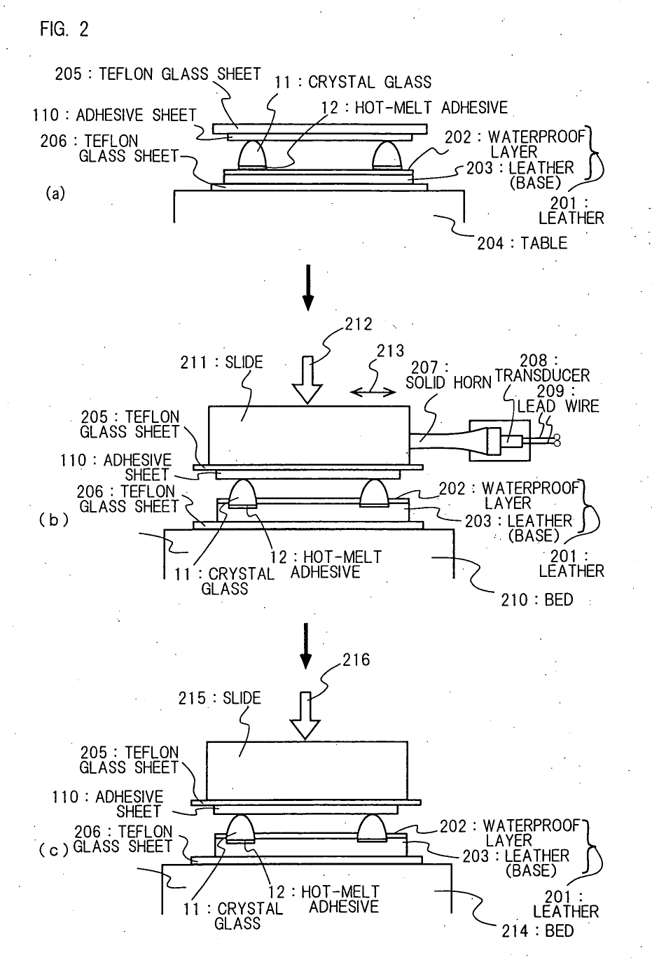

FIG. 2 shows a bonding apparatus and a bonding method in the embodiment 2.

Leather to be used as material, for example, for clothes, handbag, shoes and the like is provided with a waterproof layer on its surface so as to have waterproofing property. The waterproof layer is thin and weak in tensile strength.

Even if the small-sized crystal glass as the second member is fixed to the waterproof layer with the hot-melt adhesive (melting point of 130° C.), the waterproof layer bonded to the second member is easily peeled off therefrom with even a small impact to the second member.

In the present invention, by use of the following bonding method, the second member with a fixed shape (e.g. crystal glass) is fixed to the first member on which a layer of weak peel resistance is formed (e.g. leather).

Detailed steps of the embodiment 2 will be explained hereinafter.

FIG. 2(a) shows a first step of the bonding method in the embodiment 2.

In FIG. 2(a), the crystal glass 11 is provisionally affixed at a predetermined position (in accordance with design) on the adhesive side of an adhesive sheet 110 to which an adhesive is applied. A top surface of the crystal glass 11 is provisionally stuck to the adhesive sheet 110. The adhesive sheet 110 is used for locating the crystal glass 11 in place during manufacturing process (bonding process).

In FIG. 2(a), a Teflon (trademark) glass sheet 206 (the same one as in a third member with a flat shape and a certain degree of hardness and flexibility) is placed on a table 204. The leather 201 is spread evenly on the Teflon (trademark) glass sheet 206 and the crystal glass 11 (affixed to the adhesive sheet 110) with the hot-melt adhesive 12 pasted on its bottom is placed on a predetermined position (in accordance with design) (placing step). At the placing step carried out at normal temperatures, the hot-melt adhesive 12 (melting point of 130° C.) is in a solid state.

A Teflon (trademark) glass sheet 205 is placed on the Teflon (trademark) glass sheet 206, the leather 201 and the crystal glass 11.

The leather 201 has a leather 203 as a base on which a waterproof layer is formed.

The leather 201 may be natural leather or artificial leather. Natural leather may be any of leather of pig, bull, snake, horse, sheep or other animals. The leather 201 has the leather 203 as a base on which a thin waterproof layer 202 (vinyl layer in this embodiment) is formed.

In the embodiment 2, the Teflon (trademark) glass sheets 205 and 206 are 0.5 mm in thickness. Although the thickness of the Teflon (trademark) glass sheet may be any value equal to or greater than 0.1 mm, it should be considered that thicker sheet provides better durability. Further, the Teflon (trademark) glass sheet should have appropriate flexibility so as to apply press on a plurality of small second members equally. There is a possibility that too much thick sheet lacks appropriate flexibility.

In the case that plural types of crystal glasses having different heights are bonded to the leather at the same time, it is necessary to select a Teflon (trademark) glass sheet of optimum thickness so as to apply press of a certain amount and above on all crystal glasses.

The Teflon (trademark) glass sheet 205 carries out three functions as follows (The first member and the second member are optional).

First, in the application of press at the steps of FIGS. 2(b) and (c) as described later, the Teflon (trademark) glass sheet 205 prevents the leather 201 or the crystal glass 11 from being damaged due to contact with the metallic slide.

Secondly, even in the case that a plurality of crystal glasses attached to the leather 201 vary in height, in the application of press at the steps of FIGS. 2(b) and (c), the flat-shaped Teflon (trademark) glass sheet 205 which has appropriate hardness (not too soft) and bends suitably can apply sufficient press to a short crystal glass as well as a tall one. Depending on design, various sizes of crystal glasses may be attached to the leather. Provided that height differences among plural types of crystal glasses fall within a certain range, the use of the Teflon (trademark) glass sheet 205 makes it possible to bond plural types of crystal glasses having different heights to the leather in one bonding process.

Additionally, in the case that there is a substantial difference in size (especially height) of a plurality of crystal glasses 11 attached to the leather, the process of attaching a short crystal glass to the leather and the process of attaching a tall crystal glass to the leather are made separate processes. After carrying out the process of attaching a short crystal glass to the leather, the process of attaching a tall crystal glass to the leather is performed, so that all of the crystal glasses can be attached to the leather.

Thirdly, the Teflon (trademark) glass sheet 205 also serves as fixing the crystal glass 11 at the placed position while the Teflon (trademark) glass sheet 206, the leather 201 and the crystal glass 11 are transferred or pressed.

The Teflon (trademark) glass sheet 206 carries out two functions as follows (The first member and the second member are optional).

First, the Teflon (trademark) glass sheet 206 prevents the leather 201 from being damaged due to contact with the metallic bed.

Secondly, by mounting the leather 201 and the crystal glass 11 on the Teflon (trademark) glass sheet 206 during transfer between processes, the flexible leather 201 can be easily transferred.

In place of the Teflon (trademark) glass sheet, the third member having a flat shape and an appropriate hardness and flexibility can be used. The Teflon (trademark) glass sheet having an appropriate hardness and flexibility, excellent heat resistance and durability is suitable for the above-mentioned application.

Next to FIG. 2(a), the operation goes to a heating step of FIG. 2(b).

In FIG. 2(b), a press device comprises a bed 210 and a slide 211, and presses the Teflon (trademark) glass sheets 205 and 206, the crystal glass 11 (affixed to the adhesive sheet 110), the hot-melt adhesive 12 and the leather 201 to each other in the direction of 212.

A transducer 208 is supplied with power through a lead wire 9 in order to apply ultrasonic vibration. Vibration of the transducer 208 is transmitted to the slide 211 through a solid horn 207.

The slide 211 vibrates the crystal glass 11 through the Teflon (trademark) glass sheet 205 in the direction of 213. Pressure given by the slide 211 is of an amount large enough to transmit ultrasonic vibration to the crystal glass 11.

An ultrasonic vibrator in the embodiment 2 is an apparatus wherein a welding tip of an ultrasonic welder is replaced by the slide. The specifications of this ultrasonic vibrator are: input voltage of 200V, input current of 15 A, output electric power of 1200 W and vibration frequency of 19.15 kHz.

The crystal glass 11 is heated rapidly with ultrasonic vibration. At that time, as the leather 201 does not contact the slide 211 (or even if the leather 201 contacts the slide 211, it does not receive press owing to its flexibility and no vibration is transmitted thereto) it is not heated directly.

In the embodiment 2, heating time is 1 second. Optimum heating time is determined depending on thickness of the leather, type of the stone and the like.

By heating the crystal glass 11, the hot-melt adhesive 12 melts and the waterproof layer 202 of the leather directly contacting the crystal glass 11 is heated and removed. Since heating energy occurring at the transducer 208 focuses on the crystal glass 11 contacting the slide 211, only the waterproof layer of the leather 201 under the crystal glass 11 is heated and removed. Other part of the leather 201 is not heated, causing no deformation or deterioration.

Energy supplied to the crystal glass 11 is set to be strong enough to remove the waterproof layer of the leather immediately underneath the crystal glass 11 and not to make a through-hole in the leather.

In this way, on completion of the bonding process, the crystal glass 11 is directly bonded to the leather 203 as a base.

Preferably, at the portion immediately underneath the crystal glass 11, the waterproof layer is removed and necessary portion for supporting the leather in the direction of thickness remains without any deterioration (e.g. carbonization).

Therefore, the leather to which the crystal glass is bonded has a high peel resistance.

Next, the operation goes to a cooling step as shown in FIG. 2(c). In FIG. 2(c), the Teflon (trademark) glass sheets 205 and 206, the leather 201 and the crystal glass 11 (affixed to the adhesive sheet 110) which spread evenly on a bed 214 are cooled down while being pressed to each other by a press device (including a slide 215 and the bed 214) for 1 to 2 seconds at normal temperatures. The press applied to the crystal glass 11 and the leather 201 by the slide 215 is 5 kgf/cm² (216 is pressing direction).

As the metallic slide 215 has a large heat capacity and a high thermal conductivity, the hot-melt adhesive 12 becomes hardened rapidly and the crystal glass 11 is fixed to the leather 201.

After the hardening of the hot-melt adhesive 12, the adhesive sheet 110 is removed.

At the heating step of FIG. 2(b), only the crystal glass 11 and the portion of the leather 201 directly contacting the crystal glass 11 are heated (in other words, the leather 201 as a whole is not heated) and therefore, at normal temperatures, the temperature of the hot-melt adhesive decreases rapidly. In the present invention, it is essential to solidify the hot-melt adhesive in a pressed state, and bonding strength becomes weak if cooling starts before press.

In order to ensure sufficient bonding strength, the operation shifts from the heating step of FIG. 2(b) to the cooling step of FIG. 2(c) should be within 2 seconds, preferably within 1 second. In this embodiment, transitional time period is about 0.5 second.

At the cooling step of FIG. 2(c), due to application of press, fibers of the leather 201 are compressed rendering high density. The hot-melt adhesive 12 twines in the compressed fibers and becomes hardened. As the hot-melt adhesive 12 twines in the compressed fibers of high density of the leather 203 as a base and becomes hardened, it has stronger bonding strength than that of the prior art.

Rapidly cooled hot-melt adhesive 12 solidifies soon immediately underneath the crystal glass 11 and does not spread over the periphery of the crystal glass 11 (right and left sides of the crystal glass 11 in FIG. 2(c)). When the hot-melt adhesive 12 spreads over the periphery of the crystal glass 11, the leather 201 absorbs the hot-melt adhesive 12, thereby degenerating and hardening. The degenerate leather on the periphery of the crystal glass becomes worse in appearance and its commercial value decreases. On the other hand, according to the bonding method in the embodiment 2, as the hot-melt adhesive focuses on the part directly underneath the crystal glass 11, the bonded leather has a beautiful appearance and high commercial value.

The hot-melt adhesive 12 penetrates into fibers of the leather 201 in a compressed state and becomes hardened. Therefore, the leather 201 maintains the compressed state even after completing the bonding method in the embodiment 2. For this reason, the crystal glass 11 is embedded suitably in the leather 201, so that a finished article is excellent in appearance.

The bonding apparatus and the bonding method in the embodiment 2 are applicable to an optional first member such as cloth. Furthermore, it is possible to bond the second member directly to leather, which was conventionally difficult.

In the embodiments, the crystal glass is fixed by the adhesive sheet during manufacturing phase, and however, the crystal glass can be located in other ways.

The present invention has an advantage of achieving the method for bonding the second member with a fixed shape to the first member with a flexible and flat configuration with the hot-melt adhesive in a short process so as to have a high peel resistance and a beautiful appearance (without shrinkage of cloth or trace of press), the bonding apparatus and the bonded composition.

In the bonding method and the bonding apparatus of the present invention, at the time of melting the hot-melt adhesive, substantially only a predetermined portion of the first member is heated. The present invention has an advantage of achieving the bonding method and the bonding apparatus which prevent the first member from deteriorating due to heat.

The present invention has an advantage of achieving the bonding method for directly bonding the second member to leather having a low tensile strength in its surface, the bonding apparatus and the bonded composition.

The present invention has an advantage of achieving the bonding method for bonding various types of first members to various types of second members and the bonded composition.

The present invention has an advantage of achieving the bonding method for bonding effectively the second member to the first member without causing damage to the first member and the second member by use of the third member (preferably Teflon (trademark) glass sheet).

Although the invention has been described in some detail dealing with the preferred embodiments, the configuration details of any of the preferred embodiments disclosed herein may be changed or modified, and any changes in the combination or order of elements thereof can be accomplished without departing from the spirit and scope of the invention as set forth in the appended claims.

1. A bonding method comprising the steps of
placing a second member with a fixed shape on a first member with a flexible and flat configuration with a hot-melt adhesive being sandwiched therebetween,
heating at least said second member up to a temperature equal to or greater than a melting point of said hot-melt adhesive, and
cooling said first member and said second member while pressing said second member so as to contact said first member closely.

2. A bonding method as stated in claim 1 wherein a heating temperature is 200° C. or less and a heating time is 10 seconds or less at said heating step.

3. A bonding method as stated in claim 1 wherein said first member and said second member are pressed to each other so as to contact each other closely and said second member is heated through a press device in contact therewith at said heating step.

4. A bonding method as stated in claim 3 wherein said first member and said second member are pressed to each other so as to contact each other closely and said second member is heated through a press device by suffering ultrasonic vibration at said heating step.

5. A bonding method as stated in claim 3 wherein part of a portion of said first member contacting said second member is transmuted or removed at least partially due to heat at said heating step.

6. A bonding method as stated in claim 3 wherein said heating step is carried out so as to make a portion of said first member contacting said second member after bonding be thinner than said first member before bonding and not to have a through-hole.

7. A bonding method as stated in claim 3 wherein heating is performed at an output power of 800 to 2000 W for 3 seconds or less at said heating step.

8. A bonding method as stated in claim 3 wherein said cooling step is carried out within 2 seconds after completing said heating step.

9. A bonding method as stated in claim 1 wherein said first member is made of cloth, leather, resin or paper, and said second member is made of glass, stone, pottery, porcelain, metal or resin.

10. A bonding method as stated in claim 1 wherein a third member with a flat shape and a certain degree of hardness and flexibility is sandwiched between at least one of surfaces of said first member as well as said second member contacting said press device and said press device, and pressed at least at either of said heating step or said cooling step.

11. A bonding method as stated in claim 10 wherein said third member is Teflon (trademark) glass sheet.

12. A bonding apparatus comprising:
a heating section for heating at least a second member up to a temperature equal to or greater than a melting point of a hot-melt adhesive, while said second member with a fixed shape is placed on a first member with a flexible and flat configuration with said hot-melt adhesive being sandwiched therebetween and
a cooling section for cooling said first member and said second member while pressing said second member so as to contact said first member closely.

13. A bonding apparatus as stated in claim 12 wherein heating temperature is 200° C. or less and heating time is 10 seconds or less at said heating section.

14. A bonding apparatus as stated in claim 12 wherein said heating section presses said first member and said second member to each other so as to contact each othe closely and heats said second member through a press device in contact therewith.

15. A bonding apparatus as stated in claim 14 wherein said heating section is a ultrasonic press device which presses said first member and said second member to each other so as to contact each other closely and heats said second member by applying ultrasonic vibration to said second member through a press device in contact therewith.

16. A bonding apparatus as stated in claim 14 wherein said heating section heats at an output power of 800 to 2000 W for 3 seconds or less.

17. A bonding apparatus as stated in claim 14, further comprising a transferring section for transferring said first member and said second member from said heating section to said cooling section within 2 seconds.

18. A bonding apparatus as stated in claim 12 wherein a third member with a flat shape and a certain degree of hardness and flexibility is sandwiched between said first member as well as said second member and at least one of surfaces of said heating section or said cooling section contacting said first member or said second member, and pressed.

19. A bonding apparatus as stated in claim 18 wherein said third member is Teflon (trademark) glass sheet.

20-23. (canceled)

24. A bonding method as stated in claim 4 wherein part of a portion of said first member contacting said second member is transmuted or removed at least partially due to heat at said heating step.

25. A bonding method as stated in claim 4 wherein heating is performed at an output power of 800 to 2000 W for 3 seconds or less at said heating step.

26. A bonding method as stated in claim 4 wherein said cooling step is carried out within 2 seconds after completing said heating step.

27. A bonding apparatus as stated in claim 15 wherein said heating section heats at an output power of 800 to 2000 W for 3 seconds or less.

28. A bonding apparatus as stated in claim 15, further comprising a transferring section for transferring said first member and said second member from said heating section to said cooling section within 2 seconds.
